(19) United States
(12) Patent Application Publication
(10) Pub. No.: US 2026/0205469 A1
(43) Pub. Date: Jul. 16, 2026

(54) SYSTEMS AND METHODS FOR DISTRIBUTED NETWORK ACCESS CONTROL

(71) Applicant: Capital One Services, LLC, McLean, VA (US)

(72) Inventors: Michael SOH, Henrico, VA (US); William CRAIN, Loxahatchee, FL (US); Afnan HAQ, New York City, NY (US); Brian PATTERSON, Ashland, VA (US); David BROOKS, Falls Church, VA (US)

(73) Assignee: Capital One Services, LLC, McLean, VA (US)

(21) Appl. No.: 19/019,303

(22) Filed: Jan. 13, 2025

(51) Int. Cl. H04L 9/40

(52) U.S. Cl. CPC H04L 63/1416; H04L 63/104; H04L 63/1441

(57) ABSTRACT

An edge node may receive, from one or more cloud computing devices, a machine learning model configured to determine a risk of a threat and workflow information required to execute a workflow for the threat and generate a machine learning output that indicates the risk of the threat by inputting information regarding one or more actions into the machine learning model. The edge node may determine, based on the machine learning output that indicates the risk of the threat and based on the workflow for the threat, that indications of consent, for a particular access attempt via the edge node, are required from team computing devices, and cause transmission, to the team computing devices, requests to provide the indications of consent for the particular access attempt.

### BACKGROUND

The field of network security has experienced significant advances with the proliferation of cloud computing and the increasing importance of safeguarding electronically stored information. The need for enhanced security measures arises from concerns related to technical sabotage and theft of data, which pose substantive risks to entities reliant on cloud-based systems. Security measures in network architectures have, therefore, become a focal point for preventing unauthorized access and ensuring that networks remain resilient against external and internal threats.

Traditional methods in network security often involve static rule-based systems that can be inflexible and incapable of quickly adapting. Such systems may lack the necessary sophistication and require central processing of data, which leads to false positives that take an unduly long time to resolve. As a result, organizations may face unnecessary cloud computing disruptions due to benign network activities being flagged as threats. Attempts to address these shortcomings within existing network architectures often face limitations, such as excessive memory usage, high network latency, and inadequate network access control mechanisms. These technical problems may present a problem when attempting to improve network access control.

### SUMMARY

Methods and systems are described herein for improvements to network access control. For example, role-based access controls result in user devices being wrongly denied access until there is sufficient network data for detection of anomalous denial of access patterns and/or having to wait until network communication between the user devices and centrally located devices of a central team result in the denials being withdrawn. Using a central machine learning model may decrease the rate of user devices being wrongly denied access but requires the user devices to wait until the same machine learning model centrally processes each request for access. This may result in a significant amount of network latency. To overcome these technical deficiencies, the methods and systems described herein may provide distributed network access control that executes a machine learning model on each edge node to determine a risk of a threat from an access via the edge node. This reduces the use of network resources and network latency since the edge node does not need to communicate with and wait on a centrally located machine learning model.

Moreover, the methods and systems described herein may rely on team computing devices to provide indications of consent for denials of access to be withdrawn. The edge node may provide the requested network access after receiving the indications directly from the team computing devices via, for example, a local area network (LAN) shared by the edge node and the team computing devices. This eliminates the need for the edge node to instead of having to wait on centrally located devices to provide such indications based on the actions of the central team that is tasked with reviewing information regarding denials from all the associated edge nodes. This eliminates the network traffic and latency caused by the associated edge nodes transmitting requests for the details to the centrally located devices, the centrally located devices forwarding the requests to devices of the central team, the centrally located devices waiting on and receiving responses to the request from the devices of the central team, and/or providing the indications of consent via a network (e.g., the Internet and multiple LANs) based on that.

In some aspects, an edge node, for reducing network latency and improving network access control, the edge node, includes: one or more memories; and one or more processors, coupled to the one or more processors, configured to cause the edge node to: receive, from one or more cloud computing devices, an isolation forest machine learning model configured to determine a risk of a threat and workflow information required to execute a workflow for the threat, the threat being technical sabotage or theft of electronically stored information; identify one or more actions that occur within a particular quantity of days, correspond to the threat, and include one or more of accessing of one or more code repositories a particular quantity of times, accessing of a particular website during a particular time of day, requesting access to a cloud computing account, requesting access to a platform for storing data, requesting a particular type of access to the particular website or a different website, attempting to access a portable storage device, attempting to connect a printer, or attempting to download multiple documents; generate a machine learning output that indicates the risk of the threat by inputting information regarding the one or more actions into the isolation forest machine learning model; determine, based on the machine learning output that indicates the risk of the threat and based on the workflow for the threat, that indications of consent, for a particular access attempt via the edge node, are required from team computing devices, the particular access attempt being the requesting of the access to the cloud computing account, the requesting of the access to the platform for storing data, the requesting of the particular type of access to the particular website or the different website, the attempting to the access to the portable storage device, the attempting to connect to the printer, the attempting to download the multiple documents, attempting to access a particular type of data within a particular data structure, or a different type of access attempt; cause transmission, to the team computing devices, requests to provide the indications of consent for the particular access attempt; and provide, to the one or more cloud computing devices and for future training of the isolation forest machine learning model, feedback information that is based on whether the indications of consent, for the particular access attempt, were received from the team computing devices.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram of a system for updating a federated learning model that is used for distributed network access control, in accordance with one or more embodiments.

FIG. 1B shows an illustrative overview of user interfaces associated with providing access control, in accordance with one or more embodiments.

FIG. 2 shows an illustrative diagram of a system for training a federated learning model used for providing network access control, in accordance with one or more embodiments.

FIG. 3 shows an illustrative user interface for a workflow tool to create a workflow for a threat, in accordance with one or more embodiments.

FIG. 4 shows a flowchart of a client-side process to perform federated learning, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

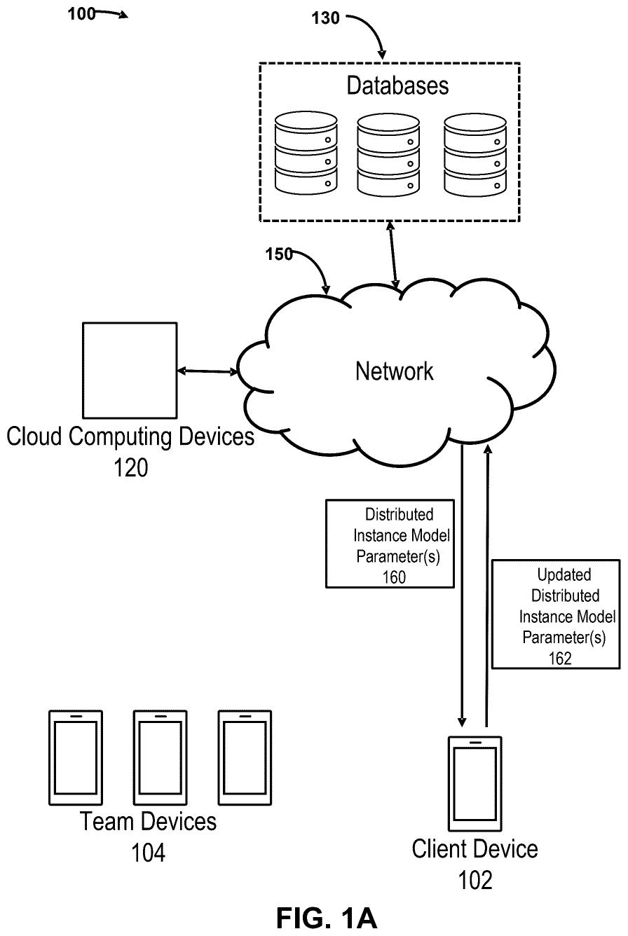

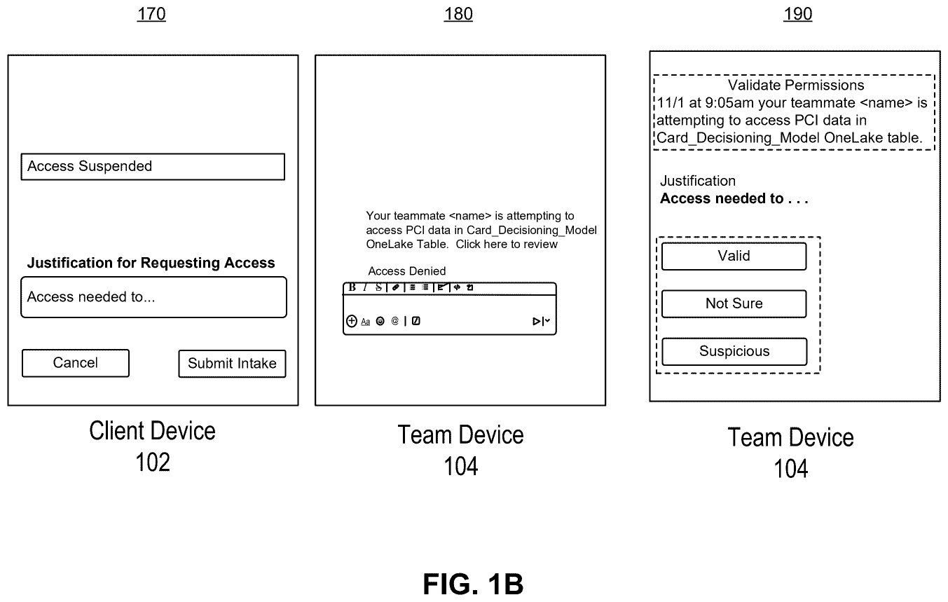

FIG. 1A shows an illustrative diagram of system 100 for updating a federated learning model that is used for distributed network access control. System 100 may include multiple client devices 102. While shown as a mobile computing device, client devices 102 may include other types of computing devices, such as a desktop computer, a wearable headset, a smartwatch, another type of mobile computing device, etc. In some embodiments, client devices 102 may communicate with various other computing devices via a network 150, where the network 150 may include the Internet, a local area network, a peer-to-peer network, etc.

Client device 102 may be associated with the same team as team devices 104. In some implementations, the client device 102 and the team devices 104 may be connected via a local area network that is separate from or part of network 150. Additionally, or alternatively, users of client device 102 and team devices 104 may be grouped as a team in an application, such as an instant messaging application shown in user interface 180 of FIG. 1B.

Client devices 102 and team devices 104 may all be edge nodes of system 100. Client device 102 may perform the same role as one of team devices 104 for other computing devices that are part of the team. Similarly, each one of team devices 104 may be one client device 102. As referred to herein, any reference to one of an edge node, client device 102, or team device 104 may also refer to all edge nodes, client device 102, and team devices 104.

As referred to herein, an edge node may include a computing device or server that sits at the edge of a network (e.g., network 150), close to the source of data generation or client device activity (e.g. performed on client device 102). The edge node may process, analyze, and store data locally, reducing latency and bandwidth use by performing computations near the client device activity instead of relying on a centralized cloud (e.g., cloud computing devices 120).

The edge node may be a client device (e.g., client device 102) or part of a network (e.g., network 150) that is connected directly or indirectly to multiple client devices (client devices 102 and team devices 104). The edge node that is a client device may include any type of computer (e.g., smartphone) that is connected to the network and is used directly by a user. The client device may execute and/or provide access to remote applications that can be used by the user to access remote data or functionality. The edge node that is part of the network may act as a bridge between local networks and other networks. The edge node may include an edge server, a network gateway, a content delivery network (CDN) node, or a cellular network edge node. Client devices 102 and team devices 104 may be part of the same local network for which the edge node is a bridge.

Client device 102 or other computing devices may send and receive messages through the network 150 to communicate with cloud computing devices 120, whereas cloud computing devices 120 may include a non-transitory storage medium storing program instructions to perform one or more operations of cloud computing devices 120. In some embodiments, cloud computing devices 120 may include one or more servers.

Further, while one or more operations are described herein as being performed by particular components of system 100, those operations may be performed by other components of system 100 in some embodiments. One or more operations described in this disclosure as being performed by cloud computing devices 120 may instead be performed by client device 102 or other computing devices described in this disclosure. For example, client device 102 may perform operations to train a distributed instance of a machine learning model used for network access control. The machine learning model may be configured to determine a risk of a threat and the workflow information required to execute a workflow for the threat. The workflow may be based on a policy for network access control.

As referred to herein, network access control may refer to procedures and mechanisms implemented to regulate when and how client device 102 can access network services and resources. This includes authentication, authorization, and the establishment of security policies aimed at protecting networked systems from unauthorized access and threats.

As referred to herein, the access of network services and resources may include one or more of accessing of one or more code repositories (e.g., Github) a particular quantity of times, accessing a particular website during a particular time of day, requesting access to a cloud computing account, requesting access to a platform for storing data, requesting a particular type of access to the particular website or a different website, attempting to access a portable storage device, attempting to connect a printer, attempting to download multiple documents, attempting to access a particular type of data within a particular data structure, or a different type of access attempt.

As referred to herein, a threat may refer to a potential risk of malicious activity such as technical sabotage or theft that could compromise electronically stored information within a network computing environment or an operation of the network computing environment. Technical sabotage may include deliberate actions intended to disrupt, damage, or manipulate information technology systems, software, data integrity, or network operations. Theft may include client device 102 improperly accessing and distributing information.

In some embodiments, a memory of client device 102 or another computing device may be used to store program instructions for applications, machine learning models, received learning model parameters, or other learning results from client computing devices, test data, or other data described in this disclosure. In addition, although some embodiments are described herein with respect to an isolation forest machine learning model, other prediction models may be used instead of or in addition to the isolation forest machine learning model. For example, cloud computing devices 120 may send, to a client computing device, a set of parameters representing a distributed instance of a random forest model, a neural network, a Naïve Bayes model, etc. Client computing device 120 may then perform a set of learning operations that causes the client computing device to update the distributed instance and send the updated model parameters back to the cloud computing devices 120.

As referred to herein, the isolation forest machine learning model may include a machine learning algorithm used to detect anomalies by, for example, determining whether a set of one or more actions fit within a threat access pattern or a good access pattern. Executing the isolation forest machine learning model may require significantly less computational processing resources and memory requirements than executing other types of machine learning models. This may allow for the isolation forest machine learning model to be executed in real-time and at an edge node (e.g., client device 102) instead of having to be executed on centralized cloud computing devices 120 that have significantly more memory and processing power than an individual edge node.

In some embodiments, the set of computer systems and subsystems illustrated in FIG. 1A may include one or more computing devices having electronic storage or otherwise capable of accessing electronic storage, where the electronic storage may include a set of databases 130. Set of databases 130 may include various values used to perform operations described in this disclosure, such as test data, aggregated machine learning model parameters, individual machine learning model parameters received from different computer devices, hyperparameters for machine learning models, other values used in this disclosure, etc.

In some embodiments, cloud computing devices 120 may send a distributed instance of a machine learning model to client device 102 and one or more other client computing devices (e.g., team devices 104). Client device 102 and the one or more other client devices may be edge nodes of system 100 as described above. Cloud computing devices 120 may retrieve the machine learning model from set of databases 130 or another memory accessible to cloud computing devices 120. For example, cloud computing devices 120 may send the machine learning model to one or more client computing devices, such as client devices 102 and team devices 104.

In some embodiments, sending a machine learning model may include sending a set of distributed instance model parameters 160. The set of distributed instance model parameters 160 may include values representing the weights, biases, activation function parameter values, hyperparameters, or other values characterizing a set of elements of the machine learning model.

Once client device 102 has received a machine learning model from cloud computing devices 120, client device 102 may store a client-side version of the machine learning model. In some embodiments, client device 102 includes an existing distributed instance of the machine learning model. Client device 102 may modify its existing set of model parameters based on the received values from cloud computing devices 120. Alternatively, if client device 102 does not include an existing machine learning model, client device 102 may implement a machine learning model based on the values received from cloud computing devices 120. For example, cloud computing devices 120 may transmit a set of values representing an isolation forest machine learning model to client device 102, where client device 102 does not include an implementation of the isolation forest machine learning model. In response, client device 102 may modify its records and update a set of values to permit an application to implement a distributed instance of the isolation forest machine learning model to predict a risk of a threat using the newly trained isolation forest machine learning model.

In some implementations, client device 102 may update its distributed instance of a machine learning model stored on a client memory (“client model instance”) by performing a training operation based on the inputs received by client device 102. Alternatively, or additionally, the client device 102 may update its client model instance based on data stored or otherwise accessible to the client device 102. For example, client device 102 may update a client model instance of a neural network such that a set of neural network layers of the neural network (e.g., the first and second layers of the neural network) are updated.

In some embodiments, client device 102 may send trained model parameters of a client model instance to cloud computing devices 120. Various actions may trigger client device 102 to transmit model parameters. In some embodiments, the criteria that must be triggered for parameter transmission from a client device 102 may include a criterion such as determining that a training metric has satisfied a training metric threshold.

In some embodiments, client device 102 may be executing a client-side training application and another client-side application in addition to the client-side training application. The other client-side application may include a web browser, a native application executing on the client device 102, etc. For example, client device 102 may be displaying a native application that enables a user to enter data into the native application. Client device 102 may be concurrently executing a client-side training application such that the user's interaction with the second application may be recorded and used to train a client-side instance model. In some embodiments, the training application may execute and update a machine learning model without interfering with a user's interactions with the other application.

In some embodiments, cloud computing devices 120 may collect machine learning model parameters from client device 102 or other devices connected to the network 150. Cloud computing devices 120 may obtain parameters, such as neural network weights, hyperparameters, or other values characterizing a version of a neural network model. For example, the client device 102 may provide, to the cloud computing devices 120, an updated set of model parameters 162 of an updated distributed instance, where the updated set of model parameters 162 may include weights, biases, and hyperparameters of a neural network model. Cloud computing devices 120 may obtain different sets of updates corresponding with different sets of data and generate corresponding different sets of combined values. As described further below, some embodiments may update a machine learning model by updating a first portion of the machine learning model based on a first set of combined values and updating a second portion of the machine learning model based on a second set of combined values.

Cloud computing devices 120 may update a machine learning model based on data provided by a set of client computing devices, where the set of client computing devices includes the client device 102. For example, after combining the data from a plurality of client computing devices that includes the client device 102, some embodiments may update the corresponding elements of a federated learning model based on the combined data. In some implementations, the combined data may represent a new weight, bias, another type of neural network parameter, another type of machine learning model parameter, etc. Some implementations may then replace an existing parameter value with the new combined parameter value. Alternatively, the combined parameter values may represent a change to an existing value, such as a change to an existing neural network weight. In response to receiving the change to the existing value, some embodiments may update the existing value with the change indicated by the combined parameter value. For example, some embodiments may add a combined value to an existing neural network weight of a neural unit. While some embodiments may determine a change as a sum to a stored value of a learning model parameter, other embodiments may determine a change as a multiplication factor, a ratio, an exponential value, etc.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 1B shows an illustrative overview of user interface 170 displayed by client device 102 and user interfaces 180 and 190 displayed by team device 104. For example, client device 102 may identify one or more actions that are performed using client device 102. Client device 102 may execute a distributed instance of the machine learning model and input information regarding the one or more actions into the distributed instance of the machine learning model. Based on the input of the information regarding the one or more actions, the distributed instance of the machine learning model may generate an output that indicates a risk of a threat.

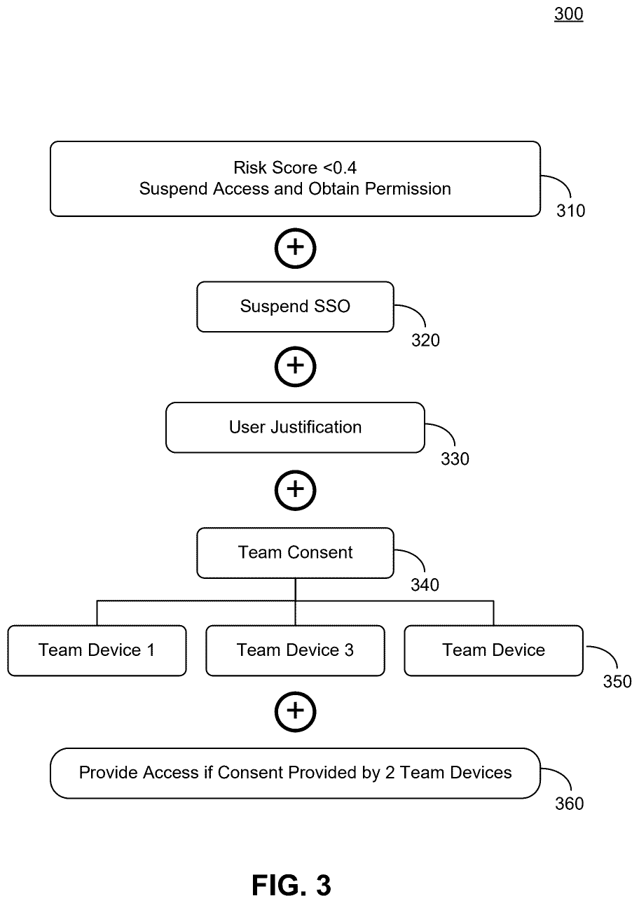

Client device 102 may then generate user interface 170 based on the output that indicates the risk of the threat and a workflow for the threat. An example workflow is described further with regards to FIG. 3. For example, the one or more actions include requesting access to a resource. User interface 170 may include a message indicating “Access Suspended.” This message may convey that the access to the resource is not allowed. Below this message, user interface 170 may further include a justification input field is provided for a user to enter the reason for requesting access to the resource. Additionally, user interface 170 may include a “Cancel” button to cancel the operations for accessing the resource and a “Submit Intake” button to submit the justification for requesting access to the resource.

If the “Submit Intake” button is selected, client device 102 may transmit messages to team devices 104 via, for example, an instant messaging application. The messages may include requests for team devices 104 to provide the indications of consent for the user to access the resource. Based on receiving and identifying one of those requests, team device 104 may generate user interface 180 of the instant messaging application. As shown in FIG. 1B, user interface 180 may include details and/or notifications relevant to the access attempt, such as a name of the teammate (i.e., the user of client device 102) requesting access to the resource, information regarding the resource, an indication that the teammate is attempting to access the resource, an indication that access to the resource has been denied to the teammate, etc. User interface 180 may also include a selectable option for a user of team device 104 to review whether the user of client device 102 should be provided with the requested access to the resource.

If the user of team device 104 selects that option, team device 104 may generate and display user interface 190. User interface 190 may include the same details as shown in user interface 180 and/or additional details regarding the access attempt, such as the time of the access attempt and detailed information regarding the resource (e.g., “PCI data in Card_Decisioning_Model OneLake table”). User interface 190 may also include text that was entered into the justification input field of user interface 170, prompting team members to review the justification provided by the user of client device 102. User interface 190 may further include buttons labeled “Valid,” “Not Sure,” and “Suspicious” to offer the reviewer options to categorize the access request based on the provided justification. If the user of team device 104 selects the “Valid” button, team device 104 may generate an indication of consent for the user of client device 102 to access the resource. Team device 104 may transmit the indication of consent to client device 102. Based on receiving the indication of consent from team device 104 and/or multiple indications of consent from different team devices 104, client device 102 may provide the user of client device 102 with access to the resource.

In some implementations, team devices 104 may provide information regarding one or more of the buttons selected (e.g., the indications of consent, indications of suspicion, and indications of ignorance) in user interface 190. Client device 102 may determine whether to provide access to the resource based on the policy and the information regarding the one or more of the buttons selected. For example, client device 102 may determine to provide the user of client device 102 with access to the resource even though one or more indications of suspicion are received from some team devices 104 along with the indications of consent. Client device 102 may provide the information regarding the one or more of the buttons selected (e.g., as part of an updated set of model parameters 162) to cloud computing devices 120 for future training of the machine learning model. User interfaces 170, 180, and 190 collectively illustrate a workflow for managing access requests locally at client device 102 and requesting consent from team devices 104 when necessary to ensure proper network access control. In this way, client device 102 does not need to communicate with cloud computing device 120 to determine the threat and/or to request the consent. This reduces the network latency associated with network access control.

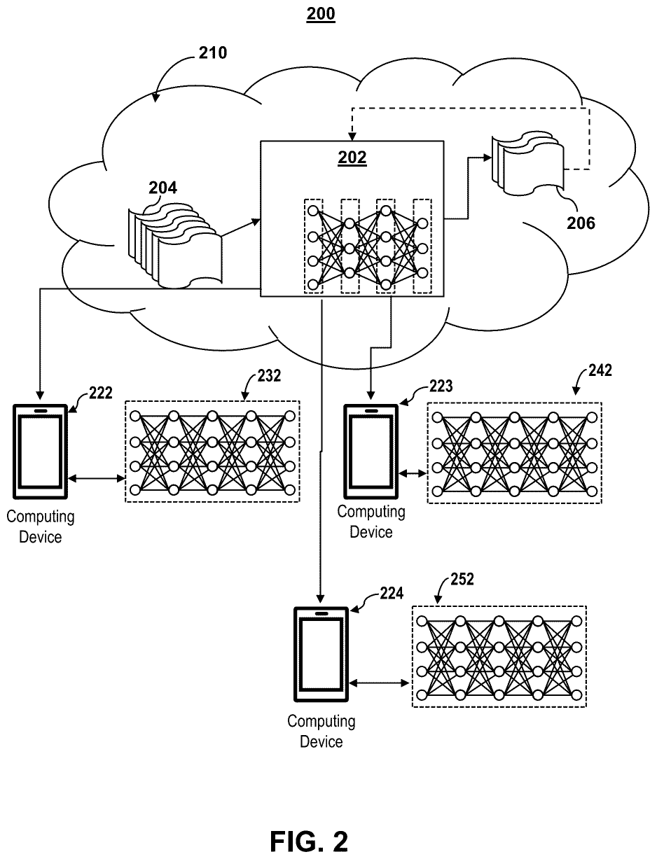

FIG. 2 shows an illustrative diagram of a system for training a federated learning model based on data provided by client computing devices (e.g., client device 102), in accordance with one or more embodiments. A system 200 may include a plurality of computing devices that includes a first computing device 222, a second computing device 223, and a third computing device 224. Though depicted as mobile computing devices, each of the computing devices 222-224 may be any computing device, including, but not limited to, a smartphone, a laptop computer, etc. The system 200 also includes cloud system 210 implemented on a distributed computer system, where the cloud system 210 may include any computing device described in this disclosure or any other type of mobile computing device, fixed computing device, or another computing device. In some embodiments, the distributed computer system may include a set of computing nodes, such as a set of servers or remote computing devices operated by a third party. The cloud system 210 may include a set of programs or computing services being executed by the distributed computer system. In some embodiments, the cloud system 210 may perform processor operations or data storage operations similar to or the same as those described elsewhere in this disclosure. For example, the cloud system 210 may perform a set of operations performed by the client device 102, team devices 104, cloud computing devices 120, network 150, or set of databases 130. Set of databases 130 may each be controlled by different computing nodes of the set of computing nodes, and a query received by the set of databases 130 may cause each node of the set of computing nodes to perform a search based on the query. For example, some embodiments may send a query to cloud system 210 to retrieve machine learning model parameters, update machine learning model parameters, etc.

In some embodiments, cloud system 210 may include a machine learning model 202. Machine learning model 202 may receive a set of inputs 204 and provide a set of outputs 206. The inputs may include training datasets, testing datasets, validation datasets, or other types of datasets. The machine learning model 202 may include an isolation forest machine learning model. In some embodiments, machine learning model 202 may include an input layer and a set of hidden layers.

Some embodiments may train machine learning model 202 in a federated fashion, where the results of training operations performed by client devices are then sent to a server or other set of computing devices to update a machine learning model stored on the server or other set of computing devices. Alternatively, or additionally, machine learning model 202 may update its configurations (e.g., weights, biases, or other parameters) based on a set of outputs 206 and reference feedback information (e.g., user indication of accuracy, reference vectors, or other information). Connection weights of machine learning model 202 may be adjusted to reconcile differences between the neural network's prediction and reference feedback. For example, an output layer of machine learning model 202 may correspond with a category (e.g., a sensitivity level), and a target token or set of context tokens associated with the target token known to correspond with that category may be provided to the input layer of machine learning model 202 during a training operation performed by cloud system 210.

In some embodiments, machine learning model 202 may use backpropagation techniques to update machine learning model parameters, where forward stimulation is used to reset weights on the “front” neural units. For example, one or more neurons (or cells) of the neural network may require that their respective errors are sent backward through the neural network to facilitate the update process (e.g., backpropagation of error). Updates to the connection weights may be correlated with the magnitude of error propagated backward after a forward pass has been completed, where such updates use various optimization techniques such as simulated annealing or gradient descent. In this way, for example, machine learning model 202 may be trained to generate more accurate predictions or labels. In some embodiments, stimulation and inhibition operations for machine learning model 202 may be structured with skips across layers, may include neural units having additional internal parameters, or may be more free-flowing, with connections interacting in a more chaotic and complex fashion.

Some embodiments may use different types of machine learning models to obtain different types of results. Furthermore, some embodiments may use a machine learning model that includes different sub-models capable of being used in series, where outputs of one sub-model may be used as inputs of another sub-model. In some embodiments, outputs 206 may be fed back to machine learning model 202 as inputs to train machine learning model 202. For example, outputs 206 may be used to label input data. An indication that an output does not match a training objective associated with the input data during a training operation may cause some embodiments to re-train machine learning model 202 and update the associated learning model parameters of machine learning model 202.

In some embodiments, cloud system 210 may distribute machine learning model 202 to computing devices 222-224. First computing device 222 may receive first distributed instance 232, second computing device 223 may receive second distributed instance 242, and third computing device 224 may receive third distributed instance 252. In some embodiments, different computing devices may receive different hyperparameters that cause the different computing devices to have different initial versions of their respective distributed instances. For example, first computing device 222 and second computing device 223 may receive a first hyperparameter value that causes each computing device to implement first distributed instance 232 and second distributed instance 242. Similarly, the third computing device 224 may receive a second hyperparameter value that causes third computing device 224 to implement third distributed instance 252.

While some embodiments may distribute hyperparameters, some embodiments may perform operations to distribute instances of a machine learning model such that each distributed instance has the same hyperparameters. Some embodiments may constrain hyperparameter values to increase accuracy during the aggregation of machine learning model parameters or other values provided by different computing devices.

Each respective device of the computing devices 222-224 may perform respective training operations to update their respective distributed instances. For example, first computing device 222 may perform training operations to update first distributed instance 232, second computing device 223 may perform training operations to update the second distributed instance 242, and third computing device 224 may perform training operations to update third distributed instance 252. Each of the training operations for each device may be performed independently, synchronously, semi-asynchronously, asynchronously, etc. Each of the computing devices 222-224 may perform different numbers of training operations, use different data for training, perform training at different times, etc.

A client computing device may collect data semi-asynchronously with respect to model training operations. In some embodiments, an application or set of applications may cause a client computing device to monitor client data continuously. This monitoring may include determining whether one or more inputs match sensitive information or other types of target information stored in the client computing device and labeling this information for later use. The application or set of applications may cause the client computing device to retrieve available labeled data in response to receiving instructions to perform a training operation or in response to determining that a training operation is to be performed by the client computing device.

Alternatively, some embodiments may synchronously perform data collection with respect to model training operations. During a synchronous data collection and training operation, an application or set of applications may cause a client computing device to wait until first receiving instructions to perform a set of training operations. In response to receiving instructions to perform training operations or determining that the training operations should commence, some embodiments operating on a client computing device may then collect and label data for use during the training operation. Alternatively, some embodiments may be triggered to collect and label data in response to receiving instructions to construct a new instance of a machine learning model.

A device of computing devices 222-224 may send the results of their respective training operation back to cloud system 210. After receiving different sets of machine learning parameters from different devices, cloud system 210 may combine model parameters from different devices. In some embodiments, cloud system 210 may segregate different machine learning parameters based on their corresponding hyperparameters. For example, cloud system 210 may combine neural network weights of first distributed instance 232 and second distributed instance 242 by determining a measure of central tendency for their respective weights. Additionally, cloud system 210 may combine neural network weights of the third distributed instance 252 with neural network weights of other distributed instances by determining a measure of central tendency for their respective weights. Furthermore, though FIG. 2 depicts the federated learning model as being deployed on cloud system 210, other embodiments may deploy a federated learning model on an on-site server, a collection of servers, a distributed computing network, etc.

FIG. 3 shows an illustrative user interface 300 for a workflow tool to create a workflow for a threat from providing access to a resource. User interface 300 may include selectable element 310, selectable element 320, selectable element 330, selectable element 330, selectable elements 350, and selectable elements 360. Selectable element 310 may indicate that selectable element 310 may be selected to indicate that if a distributed instance of a machine learning model indicates that a risk of the threat is a risk score satisfies (e.g., is equal to or higher than) a first value (e.g., 0.4) and is less than a second value (e.g., 0.6), then an edge node (e.g., client device 102) may proceed with suspending the access to the resource and providing client device 102 an opportunity to obtain permission for the access to the resource.

Additionally, or alternatively, another selectable element may be selected to indicate that the edge node may provide the access to the resource if the risk score satisfies a third value (e.g., 0.8) that is greater than the second value. Additionally, or alternatively, another selectable element may be selected to indicate that the edge node may require re-authentication of a user of client device 102 to access the resource if the risk score is less than the third value and is greater than the second value. Additionally, or alternatively, another selectable element may be selected to indicate that the edge node may deny the access to the resource if the risk score is less than the first value.

Selectable element 320 may indicate that selectable element 320 may be selected to indicate that suspending the access to the resource may include, for example, suspending single sign-on. Selectable element 320 may indicate that selectable element 320 may be selected to indicate that obtaining the permission may include client device 102 providing an opportunity to provide a justification for requesting the access to the resource. Selectable element 330 may indicate that selectable element 340 may be selected to indicate that obtaining the permission may further include requesting consent from a team associated with client device 102. Selectable elements 350 may indicate that selectable elements 350 may be selected to indicate that requesting the consent from the team associated with client device 102 may include requesting the consent from one or more team devices 104 (e.g., team device 1, team device 2, and team device 3). Selectable elements 360 may indicate that selectable elements 350 may be selected to indicate that client deice 102 may provide access to the resource if a particular quantity (e.g., 2) of team devices 104 provide the consent.

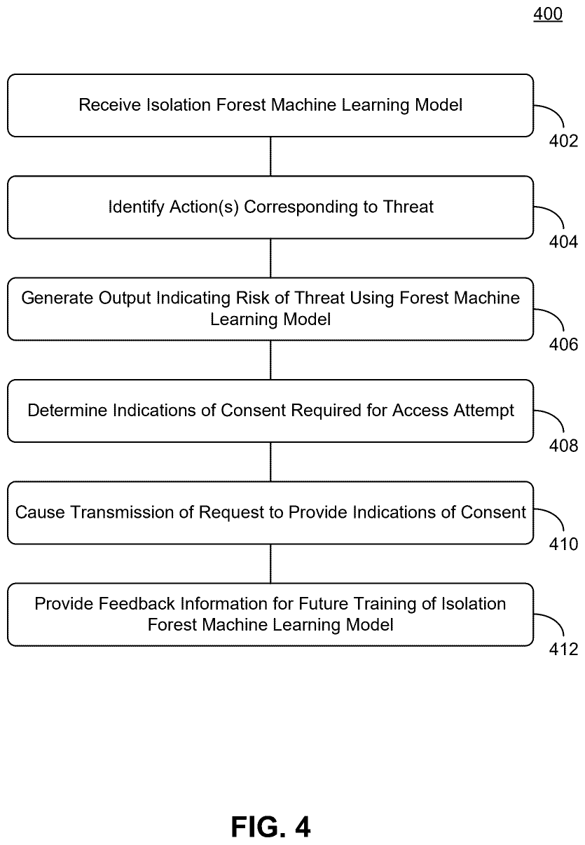

FIG. 4 shows a flowchart of the steps involved in reducing network latency and improving network access control, in accordance with one or more embodiments. For example, the system may use process 400 (e.g., as implemented on one or more system components described above) in order to provide distributed network access control.

At step 402, process 400 (e.g., using one or more components described above) may include receiving an isolation forest machine learning model. For example, client device 102 may receive the isolation forest machine learning model from cloud computing devices 120. The isolation forest machine learning model may be configured to determine a risk of a threat from client device 102 providing access to a resource. The isolation forest machine learning model may further be configured to determine workflow information required to execute a workflow for the threat. The workflow information may be based on, for example, a user interface (e.g., user interface 300 of FIG. 3) of a workflow tool being used to create the workflow. The threat may be, for example, technical sabotage or theft of electronically stored information. By client device 102 receiving the isolation forest machine learning model, client device 102 may execute the isolation forest machine learning model to determine the risk of the threat instead of having to communicate with cloud computing devices 120 and wait on cloud computing devices 120 to execute a central machine learning model to determine the risk of the threat. Client device 102 not having to communicate with cloud computing devices 120 and wait on cloud computing devices 120 may reduce network latency.

At step 404, process 400 may further include identifying actions corresponding to a threat. For example, client device 102 may identify one or more actions that occur within a particular period of time (e.g., days 2-10 after a bad performance review on day 1) and correspond to the threat. The one or more actions may include one or more of accessing a particular quantity (e.g., 20) of code repositories a particular quantity of times, accessing a particular website during a particular time of day, requesting access to a cloud computing account, requesting access to a platform for storing data or code, requesting a particular type of access to the particular website or a different website, attempting to access a portable storage device (e.g., USB drive), attempting to connect a printer (e.g., a local printer), and/or attempting to download multiple documents. By identifying the one or more actions that occur within the particular period of time, client device 102 may focus on a limited period of time instead of having to consider all of the actions that have previously occurred. This may reduce the amount of memory that client device 102 may need to use to store information about previous actions since client device 102 may not need to store information about previous actions that did not occur within the particular period of time. This may also reduce the amount of data that client device 102 may need to process since client device 102 may not need to process data regarding the previous actions that did not occur within the particular period of time. This in turn would improve the speed of client device 102 since client device 102 would need less time to process less data. This may improve network access control since client device 102 would be able to determine that access should be provided to the resource more quickly by processing the data more quickly. This may also improve network access control since client device 102 may not take into consideration unrelated actions because the actions occurred before the particular period of time, which may be the most relevant for accurately determining the risk of the threat using the isolation forest machine learning model.

Additionally, or alternatively, client device 102 may identify the one or more actions within different timeseries windows (e.g., 4 different timeseries windows). The different timeseries windows may be overlapping. By doing this, this may allow client device 102 to use multi-event threat chaining to keep track of a series of threatening events related to, for example, a single user of client device 102, a single internet protocol (IP) address of client device 102, and/or a single sign-on (SSO) login that has occurred over a period of time that corresponds to the different timeseries windows. Each timeseries window may include a particular period of time (e.g., 5 minutes). There may be a predefined interval (e.g., 1-minute slide by interval) between a beginning of one of the different timeseries windows and a beginning of a subsequent timeseries window of the different timeseries windows.

For example, the one or more actions may include one or more first actions within a first timeseries window of the different timeseries windows, one or more second actions within a second timeseries window of the different timeseries windows, one or more third actions within a third timeseries window of the different timeseries windows. Client device 102 may identify the one or more second actions based on, for example, the predefined interval that is between the beginning of the first timeseries window and the beginning of the second timeseries window. The beginning of the second timeseries window may be before an end of the second timeseries window. Client device 102 may identify the one or more first actions, the one or more second actions, and the one or more third actions based on, for example, each of those actions being related to the same single user, IP address, and/or SSO.

Additionally, or alternatively, client device 102 may identify the one or more actions within the different timeseries windows by reading access data from access logs of client device 102. Client device 102 may concatenate the data from the different timeseries window to obtain a data matrix that represents the one or more actions.

At step 406, process 400 may further include generating an output indicating a risk of a threat. For example, client device 102 may generate a machine learning output that indicates the risk of the threat by executing the isolation forest machine learning model by inputting, into the isolation forest machine learning model, information regarding the one or more actions, an IP address of client device 102 and/or what is being accessed, information regarding an application programming interface (API) endpoint associated with client device 102 and/or what is being accessed, and one or more of date information or time information that indicates when each of the one or more actions occurred. As discussed above, by client device 102 executing the isolation forest machine learning model to determine the risk of the threat instead of having to communicate with cloud computing devices 120 and waiting on cloud computing devices 120 to execute a central machine learning model to determine the risk of the threat, network latency may be reduced.

Client device 102 may generate the machine learning output that indicates the risk of the threat by inputting, into the machine learning model, first information regarding the one or more first actions, second information regarding the one or more first actions, and third information regarding the one or more third actions. Client device 102 may do that by inputting the data matrix that represents all those actions.

By using the isolation forest machine learning model, client device 102 may obtain the output that indicates the risk of the threat by executing the isolation forest machine learning model instead of having to rely on central cloud computing devices 120 to execute another type of machine learning model that client device 102 does not have enough processing power and/or memory to execute. This results in client device 102 identifying the output more reliably and quickly by eliminating the network latency from transmitting information for the input of the other type of machine learning model to cloud computing devices 120 and having to wait to receive the output from cloud computing devices 120.

At step 408, process 400 may further include determining that indications of consent are required from team devices 104. For example, client device 102 may determine to suspend a particular access attempt via client device 102 and that the indications of consent are required for the particular access attempt. The particular access attempt may be one of the one or more actions or different from the one or more actions (e.g., attempting to access a particular type of data within a particular data structure).

Client device 102 may determine to suspend the particular access attempt based on comparing the machine learning output that indicates the risk of the threat to a particular numerical value indicated by the workflow for the threat. Client device 102 determining to suspend the particular access attempt may include determining to suspend single sign-on (SSO) based on comparing the machine learning output that indicates the risk of the threat to a particular numerical value indicated by the workflow for the threat.

Based on client device 102 suspending the access, determining that the indications of consent are required, and/or the workflow for the threat, client device 102 may determine to obtain a justification for the access. Based on client device 102 determining to obtain the justification for the access, client device 102 may provide a form for the justification for the access based on determining to obtain the justification. In some implementations, client device 102 may be an edge node of a network that is separate from a user device. The access may be suspended for the user device and/or client device 102. In that situation, client device 102 may provide the form to the user device.

Client device 102 may determine that the indications of consent are required based on the machine learning output that indicates the risk of the threat and based on the workflow for the threat. By client device 102 determining that indications of consent are required from team devices 104, the system may reduce the network latency by not having to wait on centralized device(s) to provide the consent instead. Moreover, this may improve the network access control because team devices 104 are likely to more consistently and accurately provide the necessary consent than the centralized device(s) since the operators of the team computing devices are more familiar with what their teammate (i.e., the operator of client device 102) should have access to and only have to handle such request for consents from their teammates instead of an entire organization.

At step 410, process 400 may further include causing transmission of requests to provide the indications of consent for the particular access attempt. For example, client device 102 may generate forms, for the requests, that include information identifying the justification. Client device 102 may select one or more (e.g., two or three) team devices 104 based on determining that the indications of consent are required from team devices 104, based on team devices 104 being in one or more of the same team or the same local network as the user device for which the access is suspended, and/or based on the one or more team devices 104 and the user device being grouped as a team (e.g., grouped as a team by an instant messaging application). Client device 102 may transmit the forms to the one or more selected team devices 104. Based on transmitting the forms, client device 102 may receive the indications of consent, for the particular access attempt, from one or more of the one or more selected team computing devices. In some implementations, client device 102 may determine whether a quantity of the or more of the one or more selected team computing devices satisfies (e.g., is equal to or greater than) a particular threshold (e.g., 2 or a quantity of the one or more selected team computing devices). Client device 102 may determine to provide the access based on determining that the quantity of the or more of the one or more selected team computing devices satisfies the particular threshold. Client device 102 may provide the access based on determining to provide the access.

In some implementations, if client device 102 determines that the quantity of the or more of the one or more selected team computing devices does not satisfy the particular threshold or client device 102 determines that it did not receive any of the indications of consent from the team computing devices, client device 102 may determine to provide a request for consent for the access to one or more central devices (e.g., a device of a risk manager of an entity where the one or more actions occurred, a device of a cyber security operations center (CSOC) that maintains cyber security for the entity, and/or a device of an application owner of an application for which the access was suspended).

At step 412, process 400 may further include providing feedback information for future training of the isolation forest machine learning model. For example, client device 102 may determine feedback information based on whether the indications of consent, for the particular access attempt, were received from the team computing devices. Client device 102 may transmit the feedback information to the cloud computing devices 120. Cloud computing devices 120 may train the isolation forest machine learning model based on the feedback information so that the isolation forest machine learning model is able to more accurately determine a risk of a threat from an action, such as an access attempt, than it was able to before the training. Cloud computing devices 120 may generate an updated isolation forest machine learning model by training the isolation forest machine learning model based on the feedback information. Cloud computing devices 120 may transmit an instance of the updated isolation forest machine learning model to each edge node (e.g., client device 102 and team devices 104). Client device 102 may execute the updated isolation forest machine learning model for a new access attempt that occurs after client device 102 receives the instance of the updated isolation forest machine learning model from cloud computing devices 120. By doing this, client device 102 may more accurately determine the risk of the threat from the new access attempt than if client device 102 just continued using the isolation forest machine learning model without receiving the instance of the updated isolation forest machine learning model. Moreover, by cloud computing devices 120 receiving such feedback information from different edge nodes (e.g., client device 102 and team devices 104), cloud computing devices 120 may be able to improve the isolation forest machine learning model through distributed data collection from different client devices 102. This provides more relevant data for updating the isolation forest machine learning model than cloud computing devices would be able to take into cloud computing devices 120 did not have access to additional data regarding whether the isolation forest machine learning model is accurately predicting risks of threats on each individual client device 102. Client device 102 may also provide limited data in the feedback information that is most valuable for improving the isolation forest machine learning model. This may allow cloud computing devices 120 to update the isolation forest machine learning model with only that limited data instead of having to process and/or train the isolation forest machine learning model based on all the available data regarding the performance of the isolation forest machine learning model. This may improve the process for training the isolation forest machine learning model by making the process quicker and more efficient and resulting in a better updated isolation forest machine learning model that is able to more accurately determine the risk of the threat.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. An edge node for reducing network latency and improving network access control, the edge node comprising: one or more memories; and one or more processors, coupled to the one or more processors, configured to cause the edge node to: receive, from one or more cloud computing devices, an isolation forest machine learning model configured to determine a risk of a threat and workflow information required to execute a workflow for the threat, the threat being technical sabotage or theft of electronically stored information; identify one or more actions that occur within a particular quantity of days, correspond to the threat, and include one or more of accessing of one or more code repositories a particular quantity of times, accessing of a particular website during a particular time of day, requesting access to a cloud computing account, requesting access to a platform for storing data, requesting a particular type of access to the particular website or a different website, attempting to access a portable storage device, attempting to connect a printer, or attempting to download multiple documents; generate a machine learning output that indicates the risk of the threat by inputting information regarding the one or more actions into the isolation forest machine learning model; determine, based on the machine learning output that indicates the risk of the threat and based on the workflow for the threat, that indications of consent, for a particular access attempt via the edge node, are required from team computing devices, the particular access attempt being the requesting of the access to the cloud computing account, the requesting of the access to the platform for storing data, the requesting of the particular type of access to the particular website or the different website, the attempting to the access to the portable storage device, the attempting to connect to the printer, the attempting to download the multiple documents, attempting to access a particular type of data within a particular data structure, or a different type of access attempt; cause transmission, to the team computing devices, of requests to provide the indications of consent for the particular access attempt; and provide, to the one or more cloud computing devices and for future training of the isolation forest machine learning model, feedback information that is based on whether the indications of consent, for the particular access attempt, were received from the team computing devices.
2. A method comprising: receiving, by an edge node and from one or more cloud computing devices, a machine learning model configured to determine a risk of a threat of an access via the edge node; generating, by the edge node, a machine learning output that indicates the risk of the threat by inputting information regarding one or more actions into the machine learning model; determining, by the edge node and based on the machine learning output that indicates the risk of the threat and based on a workflow for the threat, to suspend the access and that indications of consent, for the access, are required from team computing devices; causing, by the edge node and based on determining that the indications of consent are required from the team computing devices, requests to be provided to the team computing devices for the indications of consent; and performing, by the edge node, an action based on whether the indications of consent, were received from the team computing devices.
3. The method of any one of the preceding embodiments, wherein generating the machine learning output comprises: generating the machine learning output by inputting the information regarding the one or more actions into an isolation forest machine learning model, wherein the machine learning model is the isolation forest machine learning model.
4. The method of clause 2, wherein generating the machine learning output comprises: generating the machine learning output by inputting the information regarding the one or more actions, an Internet Protocol (IP) address, information regarding an application programming interface (API) endpoint, and one or more of date information or time information.
5. The method of any one of the preceding embodiments, wherein generating the machine learning output comprises: generating the machine learning output by inputting, into the machine learning model, particular information regarding accessing of one or more code repositories a particular quantity of times and within a particular quantity of days, wherein the information regarding the one or more actions includes the particular information.
6. The method of any one of the preceding embodiments, wherein generating the machine learning output comprises: generating the machine learning output by inputting, into the machine learning model, particular information regarding accessing of a particular website during a particular time of day, wherein the information regarding the one or more actions includes the particular information.
7. The method of any one of the preceding embodiments, wherein generating the machine learning output comprises: generating the machine learning output by inputting, into the machine learning model, particular information regarding requesting access to a cloud computing account or a platform for storing code, wherein the information regarding the one or more actions includes the particular information, and wherein determining to suspend the access and that the indications of consent are required comprises: determining, based on the machine learning output that indicates the risk of the threat and based on the workflow for the threat, to suspend the access to the cloud computing account or the platform for storing code.
8. The method of any one of the preceding embodiments, wherein determining to suspend the access comprises: determining to suspend the access based on comparing the machine learning output that indicates the risk of the threat to a particular numerical value indicated by the workflow for the threat.
9. The method of any one of the preceding embodiments, wherein determining to suspend the access comprises: determining to suspend single sign-on (SSO) based on comparing the machine learning output that indicates the risk of the threat to a particular numerical value indicated by the workflow for the threat.
10. The method of any one of the preceding embodiments, further comprising: determining to obtain a justification for the access based on determining to suspend the access and based on the workflow for the threat; and providing, by the edge node and to a user device for which the access is suspended, a form for the justification for the access based on determining to obtain the justification.
11. The method of any one of the preceding embodiments, wherein causing the requests to be provided comprises: generating forms, for the requests, that include information identifying the justification; and causing the forms to be provided to the team computing devices.
12. The method of any one of the preceding embodiments, wherein causing the requests to be provided comprises: selecting the team computing devices based on determining that the indications of consent are required from the team computing devices and based on the team computing devices being in one or more of same team or same local network as a user device for which the access is suspended; and causing the requests to be provided to the team computing devices based on selecting the team computing devices.
13. The method of any one of the preceding embodiments, wherein causing the requests to be provided comprises: selecting the team computing devices based on determining that the indications of consent are required from the team computing devices and based on users of the team computing devices and a user device for which the access is suspended being grouped as a team by an instant messaging application; and causing the requests to be provided to the team computing devices based on selecting the team computing devices.
14. The method of any one of the preceding embodiments, wherein generating the machine learning output comprises: generating the machine learning output by inputting, into the machine learning model, particular information regarding attempting to access a portable storage device, wherein the information regarding the one or more actions includes the particular information, and wherein determining to suspend the access and that the indications of consent are required comprises: determining, based on the machine learning output that indicates the risk of the threat and based on the workflow for the threat, to suspend the access to the portable storage device.
15. The method of any one of the preceding embodiments, wherein generating the machine learning output comprises: identifying one or more first actions, of the one or more actions, within a first timeseries window; identifying one or more second actions, of the one or more actions, within a second timeseries window that is different from the second timeseries window; identifying one or more third actions, of the one or more actions, within a third timeseries window that is different from the first timeseries window and the second timeseries window; and generating the machine learning output that indicates the risk of the threat by inputting, into the machine learning model, first information regarding the one or more first actions, second information regarding the one or more first actions, and third information regarding the one or more third actions, wherein the information regarding the one or more actions includes the first information, the second information, and the third information.
16. The method of any one of the preceding embodiments, wherein identifying the one or more second actions comprises: identifying the one or more second actions based on a predefined interval that is between a beginning of the first timeseries window and a beginning of the second timeseries window, wherein the beginning of the second timeseries window is before an end of the second timeseries window.
17. The method of any one of the preceding embodiments, wherein identifying the one or more third actions comprises: identifying the one or more third actions based on the one or more third actions being related to one or more of the same user, internet protocol (IP) address, or single sign-on (SSO) as the one or more first actions and the one or more second actions.
18. The method of any one of the preceding embodiments 18, wherein performing the action comprises: providing, from an edge node that includes the one or more processors and to one or more cloud computing devices, feedback information that is based on whether the indications of consent were received from the team computing devices.
19. The method of any one of the preceding embodiments 18, wherein performing the action comprises: determining that the indications of consent were not received from the team computing devices; and providing, from an edge node that includes the one or more processors, via a network, and based on determining that the indications of consent were not received from the team computing devices, a request for consent, for the access, to a device of a risk manager of an entity where the one or more actions occurred, a device of a cyber security operations center (CSOC) that maintains cyber security for the entity, or a device of an application owner of an application for which the access was suspended.
20. One or more non-transitory, computer-readable mediums storing instructions that, when executed by a data processing apparatus, cause the data processing apparatus to perform operations comprising those of any of embodiments 1-19.
21. A system comprising one or more processors; and memory storing instructions that, when executed by the processors, cause the processors to effectuate operations comprising those of any of embodiments 1-19.
22. A system comprising means for performing any of embodiments 1-19.

What is claimed is:

1. An edge node for reducing network latency and improving network access control, the edge node comprising:
one or more memories; and
one or more processors, coupled to the one or more processors, configured to cause the edge node to:
receive, from one or more cloud computing devices, an isolation forest machine learning model configured to determine a risk of a threat and workflow information required to execute a workflow for the threat,
the threat being technical sabotage or theft of electronically stored information;
identify one or more actions that occur within a particular quantity of days, correspond to the threat, and include one or more of accessing of one or more code repositories a particular quantity of times, accessing of a particular website during a particular time of day, requesting access to a cloud computing account, requesting access to a platform for storing data, requesting a particular type of access to the particular website or a different website, attempting to access a portable storage device, attempting to connect a printer, or attempting to download multiple documents;
generate a machine learning output that indicates the risk of the threat by inputting information regarding the one or more actions into the isolation forest machine learning model;
determine, based on the machine learning output that indicates the risk of the threat and based on the workflow for the threat, that indications of consent, for a particular access attempt via the edge node, are required from team computing devices,
the particular access attempt being the requesting of the access to the cloud computing account, the requesting of the access to the platform for storing data, the requesting of the particular type of access to the particular website or the different website, the attempting to the access to the portable storage device, the attempting to connect to the printer, the attempting to download the multiple documents, attempting to access a particular type of data within a particular data structure, or a different type of access attempt;
cause transmission, to the team computing devices, of requests to provide the indications of consent for the particular access attempt; and
provide, to the one or more cloud computing devices and for future training of the isolation forest machine learning model, feedback information that is based on whether the indications of consent, for the particular access attempt, were received from the team computing devices.

2. A method comprising:
receiving, by an edge node and from one or more cloud computing devices, a machine learning model configured to determine a risk of a threat of an access via the edge node;
generating, by the edge node, a machine learning output that indicates the risk of the threat by inputting information regarding one or more actions into the machine learning model;
determining, by the edge node and based on the machine learning output that indicates the risk of the threat and based on a workflow for the threat, to suspend the access and that indications of consent, for the access, are required from team computing devices;
causing, by the edge node and based on determining that the indications of consent are required from the team computing devices, requests to be provided to the team computing devices for the indications of consent; and
performing, by the edge node, an action based on whether the indications of consent, were received from the team computing devices.

3. The method of claim 2, wherein generating the machine learning output comprises:
generating the machine learning output by inputting the information regarding the one or more actions into an isolation forest machine learning model,
wherein the machine learning model is the isolation forest machine learning model.

4. The method of claim 2, wherein generating the machine learning output comprises:
generating the machine learning output by inputting the information regarding the one or more actions, an Internet Protocol (IP) address, information regarding an application programming interface (API) endpoint, and one or more of date information or time information.

5. The method of claim 2, wherein generating the machine learning output comprises:
generating the machine learning output by inputting, into the machine learning model, particular information regarding accessing of one or more code repositories a particular quantity of times and within a particular quantity of days,
wherein the information regarding the one or more actions includes the particular information.

6. The method of claim 2, wherein generating the machine learning output comprises:
generating the machine learning output by inputting, into the machine learning model, particular information regarding accessing of a particular website during a particular time of day,
wherein the information regarding the one or more actions includes the particular information.

7. The method of claim 2,
wherein generating the machine learning output comprises:
generating the machine learning output by inputting, into the machine learning model, particular information regarding requesting access to a cloud computing account or a platform for storing code,
wherein the information regarding the one or more actions includes the particular information, and
wherein determining to suspend the access and that the indications of consent are required comprises:
determining, based on the machine learning output that indicates the risk of the threat and based on the workflow for the threat, to suspend the access to the cloud computing account or the platform for storing code.

8. The method of claim 2, wherein determining to suspend the access comprises:
determining to suspend the access based on comparing the machine learning output that indicates the risk of the threat to a particular numerical value indicated by the workflow for the threat.

9. The method of claim 2, wherein determining to suspend the access comprises:
determining to suspend single sign-on (SSO) based on comparing the machine learning output that indicates the risk of the threat to a particular numerical value indicated by the workflow for the threat.

10. The method of claim 2, further comprising:
determining to obtain a justification for the access based on determining to suspend the access and based on the workflow for the threat; and
providing, by the edge node and to a user device for which the access is suspended, a form for the justification for the access based on determining to obtain the justification.

11. The method of claim 10, wherein causing the requests to be provided comprises:
generating forms, for the requests, that include information identifying the justification; and
causing the forms to be provided to the team computing devices.

12. The method of claim 2, wherein causing the requests to be provided comprises:
selecting the team computing devices based on determining that the indications of consent are required from the team computing devices and based on the team computing devices being in one or more of same team or same local network as a user device for which the access is suspended; and
causing the requests to be provided to the team computing devices based on selecting the team computing devices.

13. The method of claim 2, wherein causing the requests to be provided comprises:
selecting the team computing devices based on determining that the indications of consent are required from the team computing devices and based on users of the team computing devices and a user device for which the access is suspended being grouped as a team by an instant messaging application; and
causing the requests to be provided to the team computing devices based on selecting the team computing devices.

14. The method of claim 2,
wherein generating the machine learning output comprises:
generating the machine learning output by inputting, into the machine learning model, particular information regarding attempting to access a portable storage device,
wherein the information regarding the one or more actions includes the particular information, and
wherein determining to suspend the access and that the indications of consent are required comprises:
determining, based on the machine learning output that indicates the risk of the threat and based on the workflow for the threat, to suspend the access to the portable storage device.

15. The method of claim 2, wherein generating the machine learning output comprises:
identifying one or more first actions, of the one or more actions, within a first timeseries window;
identifying one or more second actions, of the one or more actions, within a second timeseries window that is different from the second timeseries window;
identifying one or more third actions, of the one or more actions, within a third timeseries window that is different from the first timeseries window and the second timeseries window; and
generating the machine learning output that indicates the risk of the threat by inputting, into the machine learning model, first information regarding the one or more first actions, second information regarding the one or more first actions, and third information regarding the one or more third actions,
wherein the information regarding the one or more actions includes the first information, the second information, and the third information.

16. The method of claim 15, wherein identifying the one or more second actions comprises:
identifying the one or more second actions based on a predefined interval that is between a beginning of the first timeseries window and a beginning of the second timeseries window,
wherein the beginning of the second timeseries window is before an end of the second timeseries window.

17. The method of claim 15, wherein identifying the one or more third actions comprises:
identifying the one or more third actions based on the one or more third actions being related to one or more of same user, internet protocol (IP) address, or single sign-on (SSO) as the one or more first actions and the one or more second actions.

18. One or more non-transitory media comprising instructions, that when executed by one or more processors of a system, cause the system to perform operations comprising:
receiving a machine learning model configured to determine a risk of a threat;
generating a machine learning output that indicates the risk of the threat by inputting information regarding one or more actions into the machine learning model;
determining, based on the machine learning output that indicates the risk of the threat and based on a workflow for the threat, to suspend access and that indications of consent, for the access, are required from team computing devices;
causing, based on determining that the indications of consent are required from the team computing devices, requests to be provided to the team computing devices for the indications of consent; and
performing an action based on whether the indications of consent were received from the team computing devices.

19. The one or more non-transitory media of claim 18, performing the action comprises:
providing, from an edge node that includes the one or more processors and to one or more cloud computing devices, feedback information that is based on whether the indications of consent were received from the team computing devices.

20. The one or more non-transitory media of claim 18, wherein performing the action comprises:
determining that the indications of consent were not received from the team computing devices; and
providing, from an edge node that includes the one or more processors, via a network, and based on determining that the indications of consent were not received from the team computing devices, a request for consent, for the access, to a device of a risk manager of an entity where the one or more actions occurred, a device of a cyber security operations center (CSOC) that maintains cyber security for the entity, or a device of an application owner of an application for which the access was suspended.
